(19) United States
(12) Patent Application Publication
(10) Pub. No.: US 2026/0242224 A1
(43) Pub. Date: Aug. 20, 2026

(54) Hexagonal Crystals and Methods for Making Hexagonal Crystals

(71) Applicant: Lonnie Jackson, Houston, TX (US)

(72) Inventor: Lonnie Jackson, Houston, TX (US)

(21) Appl. No.: 19/463,046

(22) Filed: Jan. 28, 2026

Related U.S. Application Data
(60) Provisional application No. 63/759,138, filed on Feb. 15, 2025.

(51) Int. Cl. C01B 32/05

(52) U.S. Cl. CPC C01B 32/05; C01P 2002/76; C01P 2002/77

(57) ABSTRACT

Disclosed herein are compositions of matter, including hexagonal crystals, preferably hexagonal crystal lattices having a Lonsdaleite configuration having a Group 14 atom, preferably either carbon or lead atoms, at the lattice points and a Group 18 atom, preferably either helium or radon atoms, in the spaces between the lattice points. Also, disclosed are methods for making the disclosed hexagonal crystals. Preferably, it is contemplated that the hexagonal crystals disclosed herein are or can be used in processors for quantum computers, power sources in or with power systems or systems requiring power, and optical transmission devices.

### CROSS REFERENCE TO RELATED APPLICATIONS

This application claims benefit to U.S. Provisional Application No. 63/759,138, filed on Feb. 15, 2025; and this application hereby incorporates herein U.S. Provisional Application No. 63/759,138 as if set forth herein in its entirety.

### BACKGROUND

### 1. Field of Inventions

The field of this application and any resulting patent is hexagonal crystals and methods for making hexagonal crystals.

### 2. Description of Related Art

Various hexagonal crystals and methods for making hexagonal crystals have been proposed. However, those crystals and methods lack the combination of steps and/or features of the crystals and methods disclosed herein. Furthermore, it is contemplated that the methods and/or structures disclosed herein may solve certain problems that prior art methods and structures have failed to solve. Also, the methods and/or structures disclosed herein may have benefits that would be surprising and unexpected to a hypothetical person of ordinary skill with knowledge of the prior art existing as of the filing date of this application.

### SUMMARY

Disclosed herein are compositions of matter, including hexagonal crystals, preferably hexagonal crystal lattices having a Lonsdaleite configuration having a Group 14 atom, preferably either carbon or lead atoms, at the lattice points and a Group 18 atom, preferably either helium or radon atoms, in the spaces between the lattice points. Also disclosed are methods for making the disclosed hexagonal crystals. Preferably, it is contemplated that the hexagonal crystals disclosed herein are or can be used in processors for quantum computers, power sources in or with power systems or systems requiring power, and optical transmission devices.

### BRIEF DESCRIPTION OF THE DRAWINGS

FIG. 1 is a perspective view of a disclosed hexagonal crystal in a Lonsdaleite configuration.

FIG. 2 is a side view of the hexagonal crystal depicted in FIG. 1.

FIG. 3 is a top view of a disclosed hexagonal crystal depicted in FIG. 1.

FIG. 4 is a perspective view of a hexagonal crystalline structure in a Lonsdaleite configuration.

### DETAILED DESCRIPTION

### 1. Introduction

A detailed description will now be provided. The purpose of this detailed description, which includes the drawings, is to satisfy the statutory requirements of 35 U.S.C. § 112. For example, the detailed description includes a description of the inventions disclosed herein and sufficient information that would enable a person having ordinary skill in the art to make and use the inventions. In the figures, like elements are generally indicated by like reference numerals regardless of the view or figure in which the elements appear. The figures are intended to assist with the description and to provide a visual representation of certain aspects of the subject matter described herein. The figures are not all necessarily drawn to scale, nor do they show all the structural details of the systems, nor do they limit the scope of the disclosure herein.

### 2. Selected Definitions

Certain terms, as used herein, are expressly defined below.

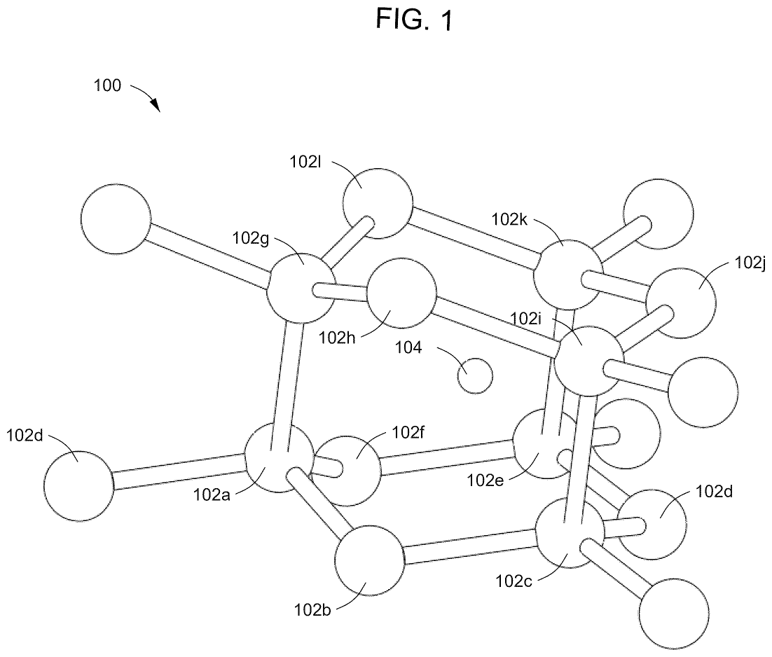

Hexagonal Crystal. As used herein, the term “hexagonal crystal” is defined as any crystal with a hexagonal crystal lattice structure, preferably two hexagonal rings covalently bonded to one another and having 12 atoms, one atom on each point of the two rings. The hexagonal crystal may also be referred to herein as a crystal, a crystalline structure, a crystal lattice, or a crystal lattice structure. In this disclosure, a preferred hexagonal crystal is a crystalline structure having the same lattice structure as Lonsdaleite or having the same lattice structure as a hexagonal diamond, preferably a hexagonal close-packed (HCP-type) preferably with the atoms having the same positions as the atoms in Lonsdaleite. One of more of the unit cells of a hexagonal crystal that is part of the compositions herein include interlocking rings of six atoms each, with at least one of the rings of the unit cell being in a first chair configuration and one of the rings of the unit cell being in a second chair configuration, in which one ring is preferably the mirror image of the other ring. The second chair configuration may be referred to as a “reverse chair configuration” and/or an “upside down configuration Illustrations of the lattice structure of the preferred hexagonal crystal having a Lonsdaleite configuration with two mirror-image chair configurations are shown in FIGS. 1-3. In preferred embodiments of the compositions and methods, the hexagonal crystals described herein include a repeating pattern of individual unit cells, each having the Lonsdaleite configuration. In other alternative embodiments, either of the hexagonal rings having mirror-image chair configurations shown in FIGS. 1-3 can be substituted with a hexagonal ring with a “boat” configuration, as discussed below.

Optical Tweezers. As used herein, the term “optical tweezer” is defined as any of the optical tweezers discussed herein, including any of the optical tweezers or optical traps disclosed in the patents and patent publications incorporated herein by reference, modified to be able to make the hexagonal crystals described herein. Generally, an optical tweezer is a known device capable of generating a focused laser beam that can trap and hold an atom, preferably near the waist of the focal point of the laser beam due to stabilizing forces created by electric-field gradients. The optical tweezers disclosed herein with reference to the disclosed compositions and methods should be capable of trapping and manipulating the individual atoms identified herein. Preferably, by independently controlling the location of the focal point, a particle (e.g., a single atom) can be trapped, moved, and assembled to form part of a structure. In the disclosure herein, the structure is one or more crystal lattices comprising two different atoms, and specifically any of the hexagonal crystal structures disclosed herein.

Carbon. The hexagonal crystals described herein may include carbon atoms, preferably Carbon-13, which is defined as an isotope of carbon having a molecular weight of 13. The carbon atom is one of the atoms located at the points of the crystal lattices disclosed herein that are formed using one or more optical tweezers.

Helium. The hexagonal crystals described herein may preferably include helium atoms, preferably Helium-3, which is defined herein as an isotope of helium having a molecular weight of three, and more specifically having two protons and one neutron. In the hexagonal crystals disclosed herein, the helium atom is located in the space of the crystal lattices disclosed herein that are formed using one or more optical tweezers.

Lead. The hexagonal crystals described herein preferably include multiple lead atoms, preferably Lead-207, which is an isotope of lead having a molecular weight of 207. The lead atom is one of the atoms located at the points of the crystal lattice resulting from transmutation of the carbon atoms that are initially part of the crystal lattice formed using one or more optical tweezers.

Radon. The hexagonal crystals described herein preferably include one or more radon atoms, preferably Radon-211, which is an isotope of radon having a molecular weight of 211. The radon atoms are in the spaces of the crystal lattice, resulting from transmutation of the helium atoms that are initially in the spaces of any of the crystal lattices formed using one or more optical tweezers.

Transmutation. The term “transmutation” as used herein means conversion of one atom to a different atom. Radioactive decay is a type of transmutation occurring naturally for certain radioactive isotopes. Cold fusion transmutation is another type of transmutation wherein the transmutation takes place as part of a cold fusion process.

### 3. Certain Specific Embodiments

Disclosed herein are compositions of matter, including hexagonal crystals, preferably hexagonal crystal lattices having a Lonsdaleite configuration having a Group 14 atom, preferably either carbon or lead atoms, at the lattice points and a Group 18 atom, preferably either helium or radon atoms, in the spaces between the lattice points. Also disclosed are methods for making the disclosed hexagonal crystals. Preferably, it is contemplated that the hexagonal crystals disclosed herein are or can be used in processors for quantum computers, power sources in or with power systems or systems requiring power, and optical transmission devices.

### 4. Specific Embodiments in the Drawings

The drawings presented herein are for illustrative purposes only and do not limit the scope of the disclosure. Rather, the drawings are intended to help enable one having ordinary skill in the art to make and use the hexagonal crystals disclosed herein.

This section addresses specific versions of hexagonal crystals shown in the drawings, which relate to structures, elements, and parts that can be part of a hexagonal crystal. Although this section focuses on the drawings herein, and the specific embodiments found in those drawings, parts of this section may also have applicability to other embodiments not shown in the drawings. It is the intent of the applicants that variations and equivalents of the disclosed versions are within the scope of the disclosure, while the description, abstract and drawings are not to be used to limit the scope of the disclosure. The disclosed versions are specifically intended to be as broad as described below and their equivalents.

Compositions: Disclosed herein are compositions comprising a hexagonal crystal having a plurality of lattice points with a first atom at each of the lattice points and a second atom in the space between the lattice points.

As used herein, the term “first atom” refers to any atom that is positioned at one or more, preferably all, of the lattice points of at least one unit of a hexagonal crystal, preferably all the units of the hexagonal crystal. Each of those lattice points may also be referred to as a “first position” in the crystal lattice. The term “second atom” refers to any atom that is positioned in a space, preferably all the spaces, between the lattice points, and each of those spaces is referred to as a “second position” in the crystal lattice.

Preferably, the atoms that are trapped using optical tweezers and then placed at the first or second position to form the hexagonal crystal lattice change via a process known as transmutation, preferably “cold fusion transmutation,” so that in any of its subsequent forms, including its final form, the crystalline structure has different first and second atoms than the first and second atoms initially placed into the crystalline structure via the optical tweezers. That is, different atoms are in the first and second positions of the crystalline structure (also referred to herein as the “crystal”) after transmutation, preferably cold fusion transmutation, takes place. Thus, the terms crystal, crystalline structure, crystal lattice, and crystal lattice structure as used herein generally refer broadly to both the initial crystalline structure that comprises the atoms placed using the optical tweezers or a subsequent crystalline structure that comprises the atoms resulting from the transmutation, including a final crystalline structure.

Preferably, the first and second atoms that are part of a subsequent crystalline structure, e.g., the crystalline structure resulting from transmutation, preferably cold fusion transmutation, have higher atomic numbers than the first and second atoms initially placed into the crystalline structure using the optical tweezers, i.e., the subsequent first and second atoms are “heavier” than the initial “lighter” first and second atoms. Preferably, however, the initial and subsequent first atoms are members of the same “group” in the Periodic Table, preferably members of Group 14 of the Periodic Table, e.g., carbon and lead, and the initial and subsequent second atoms are also members of the same “group” in the Periodic Table, preferably Group 18 of the Period Table, e.g., helium and radon.

Thus, for example, an initial first atom in a disclosed crystalline structure, placed using optical tweezers, can be a carbon atom, preferably carbon-13 (C-13), which is a member of Group 14 in the periodic table. It is contemplated that the C-13 atom may then change via transmutation, preferably cold fusion transmutation, to another atom in Group 14, e.g., lead, preferably Lead-207 (Pb-207). Preferably, the first atom in a subsequent crystalline structure, including a “final” structure that can be used as a processor for a computer, is magnetic. Thus, each of the cells of the hexagonal crystal lattice preferably has a magnetic field.

Similarly, for example, an initial second atom in the crystalline structure, placed using optical tweezers, can be a helium atom, preferably Helium-3 (He-3), which is a member of Group 18 in the periodic table. It is contemplated that the He-3 atom may then change via transmutation, preferably cold fusion transmutation, to another atom in Group 18, e.g., radon, preferably Radon-211 (Rn-211). Preferably, the second atom in a subsequent crystalline structure, including a “final” structure that can be used as a processor for a computer, is magnetic.

In other embodiments, the crystalline structure can have different atoms at each of the 12 lattice points of a hexagonal crystal. For example, zinc, iron, and oxygen can be used in the initial lattice, formed using optical tweezers, e.g., 4 atoms of each. Then, via the process of transmutation, preferably cold fusion transmutation, the zinc atoms, which are a member of Group 12 of the periodic table, becomes mercury; the iron atoms become osmium, and the oxygen atoms become polonium. In that crystalline structure carbon atoms are preferably placed into the second position, i.e., in the spaces between the lattice points, and the carbon becomes lead.

Some of the properties of lead that make it a preferred first atom in a final hexagonal crystalline structure is that it has no resonant frequency and is magnetic. Moreover, when He-3 changes via transmutation, preferably cold fusion transmutation, to radon, e.g., Rn-211, it is contemplated that the lead atoms on the lattice points that surround the radon atom in the lattice spaces prevent the radon from decaying or at least inhibit decay of the radon atom. Preferably, the radon becomes a collapsed atom, i.e., collapsing into the nucleus of the atom.

It is contemplated that a hexagonal crystal that comprises Pb-207 as a first atom and Rn-211 as a second atom, can be handled at room temperature, even though at the nano scale the crystals are below room temperature, preferably at extremely low temperatures. Accordingly, it is contemplated that the crystalline structures can be used as processors in quantum computers. It is contemplated that each of the unit cells comprising 12 atoms at the lattice points and a single atom in the space within the lattice can perform two calculations. In a quantum computer each of the unit cells having the features described herein can be referred to as Q-bits which function as processors for the quantum computer.

FIG. 1 is a perspective view of a disclosed hexagonal crystal in a Lonsdaleite configuration. As seen in that drawing, there are 12 first atoms in each unit cell, also referred to as point atoms, positioned at the lattice points. The 12 first atoms form two interlocking hexagonal rings and each of those atoms is covalently bonded to adjoining atoms as represented by the rod structures in FIG. 1. Also shown in FIG. 1 is the atom in the second position, i.e., the second atom or the space atom, in the lattice structure.

Each point atom is covalently bonded to at least two adjoining point atoms. The 6 first atoms in the bottom hexagonal ring of the unit cell are identified in FIG. 1 as 102a, 102b, 102c, 102d, 102e, and 102f. In one or more preferred embodiments, those atoms are C-13 atoms during the assembly phase using optical tweezers, and then Pb-207 after transmutation. That bottom hexagonal ring is sometimes described as having a “chair configuration.” The 6 atoms in the top hexagonal ring of the unit cell are identified in FIG. 1 as 102g, 102h, 102i, 102j, 102k, and 102l. That top hexagonal ring can be described as having an “upside down chair configuration.” In one or more preferred embodiments, those atoms are C-13 atoms during the assembly phase using optical tweezers, and then Pb-207 after transmutation.

The bottom hexagonal ring has a “chair configuration,” That is, when viewed from the side, atoms 102b and 102f are positioned slightly below atom 102a, to which they are covalently bonded, and the rods that represent the covalent bonds are at a slight downward angle. Atom 102a can be said to be at the “backrest” of the imaginary “chair” while atom 102d, on the opposite side of the bottom hexagonal ring, can be said to be at the “leg rest” of the imagination chair. A crystalline structure can also be assembled so that the chair configuration of the bottom hexagonal ring in FIG. 1 is substituted with a so-called “boat” configuration, wherein atoms 102b and 102f are positioned slightly above atom 102a, forming an imaginary bow of a boat instead of a backrest of a chair. In the boat configuration atoms 102e, 102c and 102d can be considered as forming an imaginary stern of a boat and will have the same arrangement as they do as the leg rest of chair configuration, i.e., they will look the same as they look in FIG. 1. In both the chair and boat configurations, atom 102a preferably has four covalent bonds. It is not only bonded at angles to the two adjoining atoms 102b and 102f that are part of the same hexagonal ring but is also bonded to atom 10 g that is part of the upper hexagonal ring, and another point atom 102d in an adjoining unit cell. Atom 102b is not only bonded to atom 102a but is also bonded in another direction to atom 102c. Similarly, atom 102f is not only bonded to atom 102a but is also bonded in another direction to atom 102e. As depicted in FIG. 1, atoms 102c and 102e are positioned at slight upward angles with respect to atoms 102b and 102f.

The top (upper) hexagonal ring lies directly above the bottom hexagonal ring in the crystal structure depicted in FIG. 1. Atom 102g, which is part of the upper hexagonal ring, is bonded not only to two of the atoms 102h and 102l, but also to atom 10a of the bottom (lower) hexagonal ring which is directly below atom 102g. Similarly, atom 102k is bonded to atom 102e, which is directly below it, and atom 102i is bonded to atom 102c, which is directly below it. Thus, three of the atoms at alternating points of the upper hexagonal ring (102g, 102i and 102k) are bonded to three of the atoms at corresponding alternating points of the bottom hexagonal ring (102a, 102c, and 102e).

Preferably, the upward pitch of the angle between atoms 102g and 102h is the same as the upward pitch of the angle between atoms 102g and 102l, so that atoms 102h and 102l occupy the same horizontal plane. Also, the downward pitch of the angles between atoms 102h and 102i is preferably the same as the downward pitch of the angles between 102l and 102k.

Atoms 102k and 102i are bonded to atom 102j, and the upward pitch of the angle between 102k and the upward pitch of the angle between 102i and 102j are preferably the same, so that atoms 102i and 102k lie in the same horizontal plane.

As noted above, the bottom hexagonal ring is sometimes described as having a “chair” configuration. In essence, the configuration of the six atoms of the bottom hexagonal ring is a mirror image of the configuration of the six atoms of the top hexagonal ring. Thus, the orientations described above for atoms 102a, 102b, 102c, 102d, 102e, and 102f of the bottom hexagonal ring are preferably a mirror image of the orientations of atoms 102g, 102h, 102i, 102j, 102k, and 102l of the top hexagonal ring.

A crystalline structure can also be assembled so that the upside-down chair configuration of the top hexagonal ring in FIG. 1 is substituted with a “boat” configuration, in a manner similar to the bottom hexagonal ring, discussed above. In that boat configuration, atoms 102k and 102i can be positioned slightly above atom 102j, forming an imaginary bow of a boat instead of a backrest of an upside-down chair. In that boat configuration atoms 102g, 102h and 102l can be considered as forming an imaginary stern of a boat and will have the same arrangement as they do as the leg rest of the upside-down chair configuration, i.e., they will look the same as they look in FIG. 1.

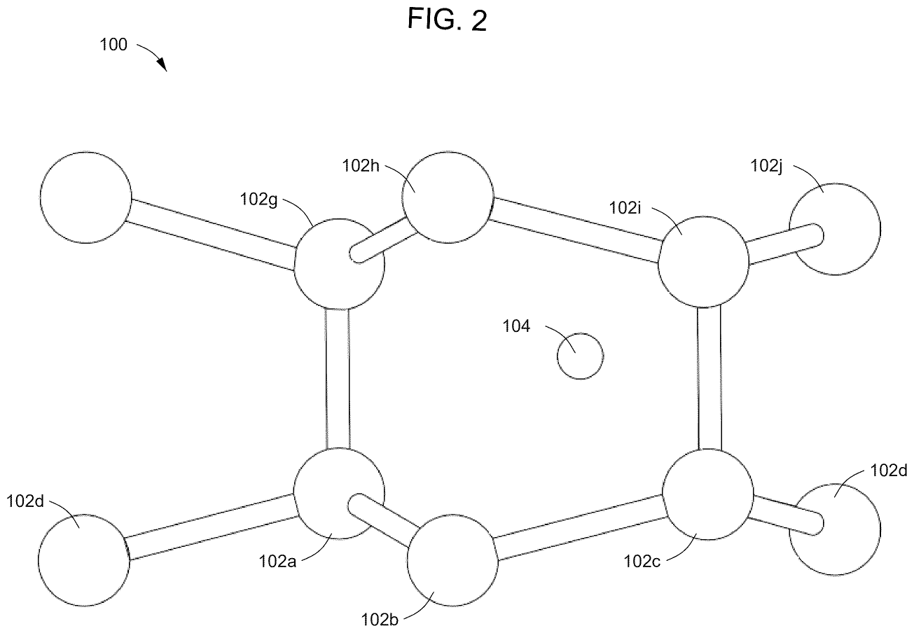

FIG. 2 is a side view of the hexagonal crystal depicted in FIG. 1. In FIG. 2, the chair configuration of the bottom hexagonal ring can be seen, in which only four of the atoms can be seen in the drawing (atoms 102a, 102b, 102c, and 102d) because two of the atoms of that hexagonal ring on the other side of the hexagonal ring are concealed. That is, atom 102f is concealed by atom 102b and atom 102e is concealed by atom 102c. FIG. 2 also shows an atom 102d on the left side, which is part of an adjoining hexagonal ring (not shown) via covalent bonding with atom 102a. FIG. 2 also shows the upside down chair configuration of the top hexagonal ring. As with the top hexagonal ring, only four of the atoms of the bottom hexagonal ring can be seen (102g, 102h, 102i and 102j) because two of the atoms of that hexagonal ring on the other side of the hexagonal ring are concealed. That is atom 102l is concealed by atom 102h and atom 102k is concealed by atom 102i. FIG. 2 also shows atom 104 occupying the second position, i.e., the space between the lattice points,

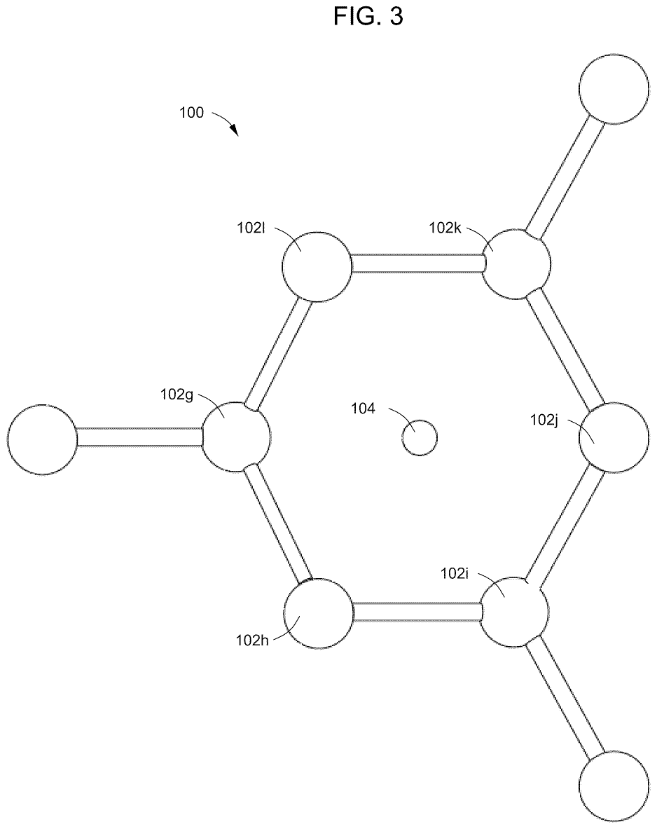

FIG. 3 is a top view of a disclosed hexagonal crystal depicted in FIG. 1. The only point atoms that can be seen in FIG. 3 are the six point atoms of the top hexagonal ring (102g, 102h, 102i, 102j, 102k, and 102l), occupying the points of the top hexagonal ring. All the atoms of the bottom hexagonal ring (102a, 102b, 102c, 102d, 102e, and 102f) are concealed in that illustration by atoms 102g, 102h, 102i, 102j, 102k, and 102l, respectively. Thus, FIG. 3 shows the alignment of the top and bottom hexagonal rings.

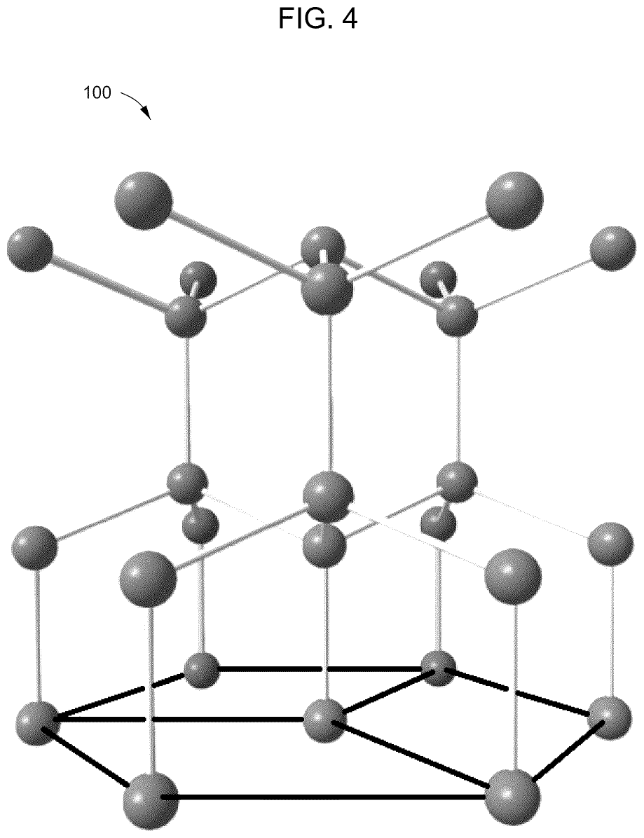

FIG. 4 also refers to a different perspective view of a hexagonal crystalline structure in a Lonsdaleite configuration having the disclosed atoms in the first and second positions.

Methods: Disclosed herein are methods for making a hexagonal crystal having a plurality of lattice points, the method comprising using an optical tweezer to assemble a hexagonal crystal with a first atom placed at one or more of the lattice points of the hexagonal crystal and using an optical tweezer to place a second atom in one or more spaces between one or more of the lattice points. Preferably the methods disclosed herein include the use of optical tweezers to assemble one or more crystalline structures having the configuration shown in FIGS. 1-3, e.g., the Lonsdaleite configuration.

Any of the hexagonal crystals described herein can be made using any of a variety of methods. Preferred methods include the use of an optical trap, which is sometimes referred to as a “optical tweezer.”

Optical tweezers can be used manually to make crystals, sometimes referred to as a “pick-and place” method. In the manual method, a human operator manually uses optical tweezers to assemble a crystal lattice by steps that include placing a “point atom” at the lattice points of a particular crystal lattice arrangement, and a different “space atom” in the space of that crystal lattice.

Preferably, two tweezers can be used to trap and place the point atoms in a hexagonal crystal lattice arrangement. For example, tweezers can be used to place any atom that is a member of Group 14, e.g., carbon atoms (preferably C-13) or lead atoms (preferably Pb-207) at lattice points in the form of any of the hexagonal crystals disclosed herein. Conventional optical tweezer equipment and procedures are used, adjusted in accordance with the specific atoms that are being trapped and manipulated. For example, it is contemplated that the tweezers can be oscillated at a frequency that corresponds to the frequency of each atom being trapped. Tweezers can be used to trap first atoms which are placed in the desired hexagonal arrangement and another tweezer is oscillated at a frequency causing those atoms to bond. Then a tweezer can be used to trap and place a second atom in the space between the lattice points.

The tweezers should be operated in an environment having a temperature corresponding to the individual atoms being trapped and placed. Preferably, the temperature should be as close to absolute zero (degrees Kelvin) as possible. The He-3 should be in liquid form when the laser beams of the tweezers are operated to trap the He-3 atom and move it into the space in crystal lattice. Accordingly, the operating environment for the tweezers should be at a temperature at or below the liquefaction point for He-3. The boiling point for He-3 is 3.2 degrees Kelvin or −269.95 degrees Celsius at one atmosphere; thus, the temperature should be maintained below that point, in order to ensure the He-3 is in liquid form when the optical tweezers are used to trap one of the He-3 atoms. Below the liquefaction point, the He-3 becomes a superfluid.

As noted above, two separate optical tweezers can be used, each optical tweezer used to trap a different atom and to construct a crystalline structure that includes both atoms, i.e., a “first atom” (e.g., the point atom) and a “second atom” (e.g., the space atom). Preferably, in the methods and compositions disclosed herein, the crystalline structure is a hexagonal crystal.

Optical tweezers are well-known to those skilled in the art as devices that can be used to move particles to desired locations. Optical traps have been used in the past to fabricate a 3×3×3 cubically packed crystal manually using a single optical trap, individually assembling each of the crystal's microspheres one at a time. This operation, and the equipment used to make the crystal, was reported in the article by F. Dawood, S. Qin, L. Li, Y. Lin, and J. T. Fourkas, in Chemical Sci. 2012, 3, 2449. More recently, an automated approach for fabricating crystals using optical tweezers was reported in the article entitled Automated Optical-tweezers Assembly of Engineered Microgranular Crystals, S. Chizari, M. P. Lim, L. A. Shaw, A. S. Austin, Prof. J. B. Hopkins, first published 27 May 2020 at https://doi.org/10.1002/smll.202000314.

Descriptions of optical tweezers and the uses of optical tweezers to trap, move, and place small particles are well-documented. For example, the design and use of optical tweezers for manipulation of small particles is disclosed and described in D. Grier and Y. Roichman, Holographic Optical Trapping, Applied Optics, Vol. 45, Issue 5, pp. 880-887 (2006) and articles cited therein. Optical tweezers are also disclosed and described in J. Leach, G. Sinclair, P. Jordan, J. Courtial, M. J. Padgett, J. Cooper, and Z. J. Laczik, 3D Manipulation of Particles into Crystalline Structures Using Holographic Optical Tweezers, Optics Express, Vol. 12, Issue 1, pp. 220-226 (2004). Various patents and publication also disclose and describe optical tweezers, including Fukuchi, U.S. Pat. No. 7,459,674, and the Abstract, Drawings, Summary of the Invention and Detailed Description of the Preferred Embodiments of that patent are hereby incorporated by reference. Also incorporated by reference is Okazaki, U.S. Patent Publication US 2004/0256542, specifically, the Abstract, Drawings, Summary of the Invention, and Detailed Description of the Invention, and Grier et al., U.S. Pat. No. 7,351,953, specifically, the Abstract, Drawings, Summary of the Invention, and Detailed Description of the Preferred Embodiments. A person skilled in the art can use the disclosures of those patents and publications to design optical tweezers and a protocol for using the optical tweezers to make the hexagonal crystals disclosed herein.

Using the automated approach described in the Automated Optical Tweezers article cited above, modified in accordance with the specific hexagonal crystals described herein, it is contemplated that holographic optical tweezers can be used to assemble a composition comprising a hexagonal crystal having the features described herein, i.e., having the lattice configuration and specific atoms at the lattice points and in the spaces. Using the approach described herein, a single laser beam can be reflected off a spatial light modulator (SLM) that can actively change the phase of the beam's wavefront to generate multiple independently controlled optical tweezers which can be arranged as desired using principles of constructive and destructive interference. Using such a method, the designated atoms can be suspended in a medium, e.g., a photocurable prepolymer medium, and dispensed through a microfluidic device to a build site where the generated holographic optical tweezers (set to a wavelength that does not cure the medium) assemble the atoms simultaneously within the desired crystal lattice configuration. A femto-second laser (set to a wavelength that does not cure the medium) can then be used, focused at the regions between the atoms to permanently join them together once in place.

It is contemplated that methods such as those described above can be both scalable and automated to fabricate hexagonal crystals consisting of desired arrangements of atoms using holographic optical tweezers and two-photon polymerization. At least one benefit of an automated method disclosed herein is that they provide sufficient flexibility for placing specific atoms in desired locations within the hexagonal crystal lattice.

Creating 3D hexagonal crystal lattices with two distinct atom species—one at lattice points and another in interstitial lattice spaces—using holographic optical tweezers involves precise control of laser-generated optical traps to manipulate and arrange the atoms. In general, such a process uses advanced optical techniques, such as spatial light modulators (SLMs), discussed below, to form complex 3D lattice structures. Below are examples of some of the steps such a process entails.

Optical tweezers are devices that are well-known by persons skilled in the art of assembling 3D crystal lattices, which use one or more focused lasers to trap and move small objects, including atoms, using light-object interactions. The tweezers can create forces to hold or reposition these objects. More specifically, optical tweezers can be used to manipulate multiple atoms and arrange the atoms into an atomic lattice assembly. In general, to assemble the 3D crystalline structure disclosed herein with single atoms, each atom is cooled, trapped, and positioned at lattice points, preferably using multiple tweezers. As discussed in greater detail below, holographic tweezers and spatial light modulators (SLMs) are used to create multiple traps, placing atoms precisely at the desired lattice points. Different laser types and wavelengths can be used for different species of atoms, which affects how they get trapped. Both Carbon-13 and Helium-3 atoms can be trapped using wavelengths in the near-infrared (NIR) region, preferably about 1064 nm.

Assembling 3D hexagonal crystal lattices involves overlapping tweezers with a cold atomic cloud that includes the subject atoms and turning on, i.e., activating, the traps to capture the atoms. Preferably, this assembly process is conducted in vacuum. SLMs can be used to help ensure one atom per trap. Techniques like atom sorting or fluorescence can be used to help remove extra atoms to get one atom per trap. Gray-molasses loading can be used to control collisions, aiding in scaling atom-array assembly. Atoms can be moved between traps or reloaded to ensure each lattice point has exactly one atom, thus improving precision. As discussed in greater detail below, atoms can be cooled in various ways including using a magneto-optical trap (MOT) to create a cold atomic cloud, making them easier to manipulate. This step helps achieve the low temperatures needed for precise trapping.

As discussed in greater detail below, fluorescence imaging can be used to help detect which traps have atoms. Then adjustments are made to ensure each lattice point has exactly one atom. Once arranged, optical tweezers hold the atoms in place, and for long-term stability, atoms can be transferred to a deeper trap or optical lattice.

Assembling one or more 3-D hexagonal crystal lattices each having a first atom (e.g., Carbon-13 or another Group 14 atom) at the lattice points and a second atom (e.g., Helium-3 or another Group 18 atom) in the lattice spaces (the interstitial spaces) using optical tweezers involves multiple steps.

### Defining the Lattice Geometry

One of the first steps is to define the lattice geometry and identify the atom species that will be occupying the lattice structure. In the specific embodiments disclosed herein, the lattice geometry is preferably a hexagonal close-packed (HCP). The HCP lattice is preferably non-Bravais, featuring two non-equivalent sublattices, ideal for holding two different atom species. The lattice parameters can be defined. As an example, the ratio of the edge length (a) of the hexagonal base to the height (c) of the prism can be c/a≈1.633. More specifically, for example, a can be 500 nm for optical trap compatibility. One atom is assigned to the lattice points (e.g., carbon-13) and another atom is assigned to the interstitial sites (e.g., helium-3). In HCP, tetrahedral sites can be at coordinates (0,0,3/8) and octahedral sites at (1/3,1/3,1/4).

After the lattice geometry is selected, the two atom species should be evaluated to determine if they have compatible optical trapping properties (e.g., similar polarizabilities at the laser wavelength) to be trapped by the same optical lattice. The size differences between the atoms should be evaluated as well, such as the ratio of the atomic radii of the two atoms, which tends to influence stability in binary lattices. Preferably, for an HCP-like structure, any ratio between 0.44 and 0.90 provides stability.

Next, a holographic optical tweezer (HOT) system should be selected, designed, and assembled. Generally, HOT systems employ laser beams which are preferably focused through a high numerical aperture objective to form individual traps. Spatial light modulators (SLMs) are employed to aid in the creation of multiple traps in a programmable pattern, such as the hexagonal lattices described elsewhere herein, for trapping and manipulating the Carbon-13 and Helium-3 atoms. HOTs use one or more laser beams modulated by an SLM to create multiple optical traps in a desired 3D pattern. The SLM imprints a computer-generated hologram (CGH) onto the laser's wavefront, splitting it into multiple beams that focus at specific points to form traps. The SLM is preferably a liquid crystal on silicon (LCoS) device. The SLM modulates the phase, amplitude, or polarization of the laser beam. By displaying a phase hologram, it controls the position and intensity of each trap.

To form the hexagonal crystal lattice, the SLM is programmed with a CGH calculated to produce a 3D array of focal points arranged in the desired hexagonal pattern, e.g., the Lonsdaleite structures disclosed elsewhere herein including in the drawings. Any programming involves one or more algorithms preferably iterative Fourier transform algorithms (IFTAs) or direct superposition to compute the phase pattern. Examples of hologram design algorithms include the Gerchberg-Saxton or direct binary search (DBS) algorithms to compute phase holograms that produce the desired 3D intensity distribution for a hexagonal lattice. The selected algorithms should provide for dynamic scaling and rotation of the lattice. The so-called Talbot effect should be incorporated to create repeating 2D planes of optical traps, forming a 3D lattice. As discussed below, the Talbot effect can be used to generate periodic focal planes (e.g., every 100 μm) by passing laser light through a microlens array or SLM-generated grating, wherein plane spacing to ~10 μm or less can be implemented for atom-atom interactions.

Thus, Holographic optical tweezers with SLMs can form a hexagonal crystal lattice for trapping Carbon-13 at lattice points and Helium-3 in interstitial spaces by using the CGHs to create precise, reconfigurable trap arrays. Key processes include hologram computation, hybrid trap array generation, and in situ feedback control. The summary, detailed description, and drawings of U.S. Pat. Nos. 6,055,106, 5,416,618, and 10,761,481 and hereby incorporated herein by reference, particularly in reference to those key processes.

To trap different species (e.g., Carbon-13 and Helium-3) with distinct optical requirements, a hybrid optical trap array (HOTA) can be used. This involves generating a mix of trap types (e.g., Gaussian point traps for Carbon-13 and deeper traps for Helium-3) within the same lattice. The SLM can be operated to display a composite hologram that encodes both lattice-point and interstitial traps with tailored intensities and positions. Real-time imaging and feedback systems can be used to monitor the positions of trapped atoms. The SLM can adjust the hologram to correct misplacements, preferably achieving high-fidelity rearrangements (e.g., 99% success for 10 μm translations of rubidium atoms). The SLM can also dynamically shift trap positions to transport Carbon-13 or Helium-3 atoms within the lattice, enabling studies of lattice dynamics or quantum interactions.

Carbon-13 and Helium-3 have different polarizabilities and masses, requiring distinct trap depths and laser wavelengths. The SLM should balance these requirements. A hexagonal lattice for atomic trapping can have lattice constants of 0.5-10 μm.

The following US patents and published patent applications disclose processes or systems related to the use of HOTs and SLMs to create complex trap arrays. Although these patents do not expressly mention Carbon-13 or Helium-3 atoms, a person skilled in the art of operating HOTs and SLMs to assemble 3D lattice structures can adapt the disclosed processes and systems to form a hexagonal crystal lattice for trapping Carbon-13 and Helium-3 atoms.

U.S. Pat. No. 6,055,106 to Grier et al. is entitled Apparatus for Applying Optical Gradient Forces. The summary, detailed description, and drawings of the patent are hereby incorporated herein by reference. Among other things, this patent discloses devices and techniques for manipulating microscopic particles using optical tweezers (traps). It also discloses devices and techniques for carrying out optical trapping in three dimensions and for trapping particles using optical tweezers. The patent also describes the use of computer-generated holograms to split the light into preselected patterns. The manipulation of microscopic particles can be extended to atomic trapping of atoms including carbon-13 and helium-3.

U.S. Pat. No. 5,416,618 to Juday is entitled Full Complex Modulation Using Two One-Parameter Spatial Light Modulators. The abstract, summary, detailed description, and drawings of the patent are hereby incorporated herein by reference. A primary thrust of this patent is the designs and uses of spatial light modulators. Among other things, this patent describes methods for achieving full complex (amplitude and phase) modulation using two SLMs, enabling improved control over light fields. The patent describes optically additive or multiplicative architectures for combining SLM actions, which enhance the ability to create complex trap patterns with high efficiency. As discussed elsewhere herein, spatial light modulation (SLM) can be used with optical tweezers to assemble and manipulate the atoms and the 3D crystalline structures described herein.

U.S. Pat. No. 10,761,481, to Kroll et al. is entitled Holographic Display. The abstract, background, summary of the invention, detailed description, and drawings of the patent are hereby incorporated herein by reference. This patent discloses a holographic display system using an SLM with integrated circuitry for encoding holograms. While focused on display applications, the SLM technology supports high-resolution phase modulation for creating complex light fields, applicable to HOTs for atomic trapping.

U.S. Pat. No. 7,202,919 to Edwards is entitled Holographic Data Storage with PDLC Spatial Light Modulator Generating Reference and Object Beams. The abstract, summary, background, detailed description, and drawings of the patent are hereby incorporated herein by reference. This patent describes an SLM using polymer-dispersed liquid crystal (PDLC) elements for holographic data storage, capable of encoding bit maps into a laser beam. The SLM's ability to control light on a pixel-by-pixel basis can be adapted for HOTs. The pixel-level control disclosed in this patent is applicable to creating precise trap arrays.

Published US Patent Application No. 2002/0149584A1, to Simpson et al. is entitled Reflective Coherent Spatial Light Modulator. The summary, detailed description, and drawings of the application are hereby incorporated herein by reference. The application discloses SLM-based holographic systems for creating complex light fields, which could include optical tweezers. For example, applications filed by Apple Inc. and others detail SLMs for modulating light to produce holographic images or trap arrays, with beam steering and trap reconfiguration capabilities. These applications cover technologies for dynamic trap array generation, which could be adapted for a hexagonal lattice with atomic trapping.

As mentioned elsewhere herein, a Talbot Tweezer Lattice can be used to create a hexagonal lattice with one species at the lattice points, and another HOT used to trap the second species in the interstitial sites. The Talbot Tweezer Lattice is a platform that integrates optical tweezers with the Talbot effect, an optical phenomenon wherein a periodic structure is self-imaged at regular intervals along the propagation direction. This combination enables the creation of three-dimensional (3D) optical lattices, which are arrays of potential wells where ultracold atoms can be trapped. The lattice's flexibility provides configurable geometries, including hexagonal patterns.

Using a Talbot Tweezer Lattice, traps are needed at both the lattice points and interstitial positions. The Talbot effect preferably replicates the desired patterns. The initial trapping pattern should be designed to include spots at both hexagonal lattice points and interstitial positions. An SLM or specific mask can be used for this. Preferably, the Talbot effect is used to replicate this pattern in 3D, creating a lattice with the desired structure in each plane. Then, species-specific trapping is used to load different atoms into the traps.

A 3D hexagonal crystal lattice has six-fold rotational symmetry, with atoms at corners and interstitial sites like hexagon centers. The goal is to place one atom type at all the lattice points, with another atom type in the spaces, thus forming a composite lattice with the desired placements of atoms. Optical lattices can be adjusted to trap different species using laser wavelength and intensity. Two schemes, tune-in and tune-out, allow selective trapping for mixtures of different atoms. The tune-in scheme, or approach, uses near-resonant detuning for stronger potential, while the tune-out scheme zeros the dipole for one species. The Talbot Tweezer Lattice can be used to design patterns with spots at both lattice points and interstitials, then replicate them in 3D using the Talbot effect, resulting in a dual-species hexagonal lattice.

Thus, a Talbot Tweezer Lattice can be used to create any of the hexagonal crystal lattices disclosed herein with one type of atom at the lattice points (preferably the carbon-13 atom) and another type of atom in the lattice spaces (preferably helium-3) by carefully designing the initial trapping pattern and using species-specific laser techniques.

### Cooling the Atoms

As mentioned above, one of the first steps is to prepare the atoms that are to be placed into the lattice, which for the 3D hexagonal lattices disclosed herein are preferably Carbon-13 atoms and Helium-3 atoms. Preparation of the atoms preferably begins with cooling of the atoms, and each of the cooling steps below is preferably conducted in a vacuum. The atoms should be cooled to temperatures on a microkelvin level. Cooling the Carbon-13 atoms and the Helium-3 atoms involve the same or similar methods and equipment. Carbon-13 atoms can be trapped and cooled to form a cold atomic cloud of approximately 10 degrees K. Helium-3 atoms can be trapped and cooled to form a cold atomic cloud in the millikelvin range (e.g., 1-10 mK).

One way to cool the C-13 atoms is with a three-dimensional magneto-optical trap (MOT) which can be used to trap and cool the C-13 atoms using laser beams and magnetic fields, preferably reaching sub-microkelvin temperatures. Likewise, Helium-3, which is a fermion, can also be trapped and cooled in a MOT where it preferably requires metastable states (e.g., 2³S₁). Using the MOT can achieve microkelvin temperatures for Helium-3.

Another way to cool both Carbon-13 atoms and Helium-3 atoms is with buffer gas cooling. For Carbon-13, the atoms are ablated into a helium buffer gas maintained at cryogenic temperatures (e.g., 6 K). Collisions with cold helium atoms transfer kinetic energy, thus rapidly cooling the carbon atoms to around 10 K within tens of microseconds. The equipment can include a copper cell anchored to a closed-cycle helium-3 refrigerator, maintaining the cell at 3.2 K without evaporative cooling. When buffer gas cooling is used to cool Helium-3, the atoms are cooled by collisions with a colder helium-3 or helium-4 buffer gas in a cryogenic cell, often maintained by a helium-3 refrigerator. This process can achieve temperatures around 1-10 mK for the Helium-3.

Yet another process for cooling helium atoms is evaporative cooling. After initial buffer gas cooling, evaporative cooling can be used to remove high-energy atoms from a magnetic or optical trap, lowering the temperature to the sub-millikelvin range (e.g., 0.1 mK). Evaporative cooling is fairly common in ultracold gas experiments. Either helium-3 refrigerators or cryostats may be used for Helium-3, resulting in ultracold helium-3 clouds having temperatures below 1 mK (e.g., 0.1-0.5 mK).

An additional way to cool the Carbon-13 atoms is by laser cooling which can be used to reduce the temperature of the Carbon-13 to the microkelvin range by using two-photon excitation to slow the carbon atoms. Precise laser systems (e.g., single-mode pulsed lasers in the deep ultraviolet region) are preferably used to target specific transitions, such as the 3D two-photon transition.

Yet another way to cool the Carbon-13 atoms is using doppler spectroscopy to characterize and optimize the cooling process, potentially enabling ultracold clouds below 100 μK.

Helium-3 gas can also be cooled using cryogenic cooling with Helium-3 refrigerators. Helium-3 refrigerators or cryostats use liquid helium-3's low boiling point (3.19 K at standard pressure) to cool systems. Advanced setups with throttle valves and heat exchangers can reach sub-millikelvin temperatures.

The cooling methods described above are known to those skilled in the art of cooling atoms. Various patents and patent applications describe aspects of those cooling methods. U.S. Pat. No. 5,338,930A is entitled Frequency Standard Using an Atomic Fountain of Optically Trapped Atoms. The summary, detailed description and drawings in that patent are hereby incorporated herein by reference. The patent describes laser cooling and MOT for cesium atoms, cooling to ~250 μK and further to <10 μK. The same techniques (laser cooling and MOT) can be applied to carbon-13 with appropriate laser tuning.

U.S. Patent Application Publication No. 2013/0329844A1 to Leal-Quiros et al. is entitled Method for Producing Helium-3 Using a Hydrogenated Lattice. The summary, detailed description and drawings in that patent are hereby incorporated herein by reference. That application discusses helium-3 in a fusion context and includes cold atom manipulation techniques in a lattice, which is applicable to cooling processes for Helium-3. Although that application is focused on helium-3 production, the processes disclosed therein discuss cold atom manipulation in a lattice and are adaptable to cooling of carbon-13.

U.S. Pat. No. 4,707,998 to Linner is entitled Apparatus and Method for Ultrarapid Cooling of Biological Samples. The summary, detailed description and drawings in that patent are hereby incorporated herein by reference. The patent describes a cryostat using a two-stage pulse-tube cryocooler to produce liquid helium-3 or helium-4 for cooling devices to millikelvin temperatures. The system isolates vibrations, suitable for maintaining cold helium-3 clouds. That patent also discusses a helium cryopump system that cools the surfaces of biological samples to cryogenic temperatures using helium gas. While focused on biological samples, the cooling technology is applicable to helium-3 atomic clouds, achieving millikelvin ranges.

U.S. Pat. No. 10,859,293 to Wu et al. is entitled Mechanical Vibration-Isolated Liquid Helium Consumption-Free and Extremely Low Temperature Refrigeration System. The summary, detailed description and drawings in that patent are hereby incorporated herein by reference. Among other things the patent describes a closed-cycle cryogenic cooling system with helium-3 vessels, achieving sub-millikelvin temperatures. Cooling methods are disclosed for both carbon-13 and helium-3, using helium gas at 3-6 K to cool atoms to 10 K (carbon-13) or 1-10 mK (helium-3).

### Trapping the Atoms

After cooling, individual traps are formed for the atoms, using one or more laser beams having a wavelength suited to the atomic species, e.g., carbon-13 or helium-3.

Carbon-13, a stable isotope, is polarizable and can be trapped in optical dipole traps created by tightly focused laser beams of the HOTs. The traps at the lattice points are positioned to form the vertices of the hexagonal lattice.

A laser beam is modulated by the SLM to create high-intensity focal spots at the lattice points. The gradient force of the optical trap confines Carbon-13 atoms, which are in the cold atomic cloud discussed above, and which have been cooled to microkelvin temperatures to reduce thermal motion and ensure stable trapping. The SLM's high-resolution pixel array (e.g., 1920×1080 pixels) provides for precise positioning of traps with sub-micrometer accuracy, essential for aligning traps in a hexagonal lattice with lattice constants on the order of micrometers.

Then, the species B atoms should be placed in the interstitial sites of the lattice structure. The SLM can be adjusted to generate a second set of optical traps at one or more of the interstitial sites (e.g., tetrahedral voids at (0,0,3/8) relative to the lattice points). Accomplishing such adjustment may involve using a separate laser wavelength or polarization to distinguish the traps for species B from traps for species A. For example, a blue-detuned laser can be used for species B (e.g., helium-3) if trapping at intensity minima is needed. Alternatively red-detuned traps with precise spatial offsets can be used. The species B atoms are loaded into the interstitial traps, ensuring minimal crosstalk with species A traps. The DBS algorithm can define intensity zeros between traps to prevent atom stacking.

A variety of methods can be used to trap different atoms in these positions. For example, the laser wavelength can be tuned so one type of atom, e.g., the Carbon-13 atom, is strongly trapped at the lattice points, while the other type of atom, e.g., Helium-3, is trapped in the lattice spaces. Techniques like the “tune-in” scheme (making a stronger trap for one species), discussed above, or the “tune-out” scheme (choosing a wavelength where one species isn't trapped) help achieve this.

The atoms are loaded into these traps using cooling and precise laser control, ensuring the first atom, e.g., Carbon-13, stays at the points and the second atom, e.g., Helium-3, stays at the spaces.

A hexagonal crystal lattice is characterized by a unit cell with six-fold rotational symmetry, commonly seen in 2D or 3D arrangements. For the hexagonal lattices described herein, one type of atom (e.g., the carbon-13 atom) is located at the lattice points (the vertices of the hexagons) and another (e.g., the helium-3 atom) in the “lattice spaces,” which refers to interstitial sites, such as the centers of the hexagons.

For the assembly of multi-species lattices, selective trapping of different atomic species is preferable. Two key approaches provide for that selective trapping. The tune-in approach uses near-resonant detuning to create a stronger trapping potential for one specific element. It enhances the trap depth for the targeted species while minimally affecting others. With the tune-out approach, the trapping wavelength is chosen to lie between two strong transitions of an atom, resulting in zero induced dipole moment for that species (no trapping), while other species with nonzero dipole moments are trapped. Each of these approaches enables independent addressing of atomic species, allowing for the creation of an optical lattice for one species (e.g. carbon-13) with little effect on another species (e.g., helium-3).

To form a hexagonal crystal lattice, the Talbot Tweezer Lattice must be configured to create a hexagonal pattern. This is achieved by designing the initial trapping pattern using tools like spatial light modulators or masks to include spots at both (a) the hexagonal lattice points, corresponding to the vertices; and (b) interstitial positions, such as the centers of the hexagons, which form another set of points potentially arranged in a shifted hexagonal lattice.

The Talbot effect then replicates this pattern in 3D, creating multiple planes with the same structure. For instance, if the initial pattern has traps at both positions, the replicated planes will maintain this dual-position arrangement.

To place different atom types at these positions, species-specific trapping is applied.

For example, the tune-out approach can be used to create traps at lattice points that are deep for species A (e.g., Carbon-13) and shallow for species B (e.g., Helium-3), ensuring species A is trapped there. Then another laser configuration is used, possibly with a different wavelength, to create traps at interstitial sites that are deep for species B (e.g., Helium-3) and shallow for species A (e.g., Carbon-13), ensuring species B is trapped there.

### Activating the Traps

The next step is to capture the atoms and activate the traps. The optical tweezers can be made to overlap with the cold atomic cloud, and the traps activated to capture the atoms. Loading efficiency is enhanced by techniques like gray-molasses cooling, which helps control collisions to ensure high occupancy.

After trapping the atoms and positioning them at the lattice points and lattice spaces, the optical tweezer array is then aligned to overlap with the cold atomic cloud by imaging the cloud's fluorescence or absorption using a high-NA objective and adjusting the laser beam's position. The SLM dynamically reconfigures the hologram to position the hexagonal lattice within the cloud's spatial extent (e.g., a 26×26 μm² area). Acousto-optic deflectors (AODs) or galvanometer mirrors may assist in fine-tuning the beam's position to ensure the traps coincide with the densest part of the cloud. The laser wavelength (e.g., 820 nm or 1064 nm) is chosen to be far-off-resonant for both Carbon-13 and Helium-3 to create attractive dipole traps without significant heating.

Carbon-13 atoms are not commonly trapped in optical tweezers due to their chemical reactivity and the difficulty of isolating atomic carbon in ultracold conditions. Helium-3, while trappable, requires specialized cooling due to its low mass and weak polarizability, which reduces trap depths. The overlap process should account for these differences, potentially using separate MOTs for each species and merging the clouds before loading into the tweezers.

Once the tweezer array overlaps with the cold atomic cloud, the traps are activated to capture single atoms through the following process. First, the optical tweezers are turned on by illuminating the SLM with the laser beam, creating the hexagonal lattice of traps. Atoms in the cloud experience an optical dipole force due to the intensity gradient of the focused laser spots. The trap depth (e.g., ~1.4 mK for rubidium at 820 nm) is sufficient to capture atoms with kinetic energies below this threshold (i navy blueK temperatures correspond to energies of ~10-100 nK). The traps are stochastic, meaning atoms are loaded probabilistically based on their position within the cloud. For a hexagonal lattice, the trap spacing and depth are optimized to maximize single-atom occupancy (e.g., ~50% filling fraction initially).

For single atom trapping, to ensure single-atom occupancy, the traps exploit collisional blockades (for fermions like Helium-3) or light-assisted collisions (for bosons or fermions). For Helium-3, the Pauli exclusion principle limits occupancy to one atom per trap due to its fermionic nature. For Carbon-13, if treated as a neutral atom, light-assisted collisions can be induced by tuning the trap laser closer to resonance, causing pairs of atoms to be ejected, leaving single atoms. The SLM's high resolution allows precise control over trap intensity and position, minimizing defects.

After initial loading, defects (empty or overfilled traps) are common. Dynamic holographic tweezers, controlled by the SLM, rearrange atoms to achieve the desired pattern (Carbon-13 at lattice points, Helium-3 in interstitial spaces). This involves real-time imaging of atom fluorescence (e.g., using an EMCCD camera) to identify occupied traps, followed by updating the SLM hologram to move traps and transport atoms to their target positions. Feedback control ensures high fidelity (e.g., 99% success for 10 μm translations). Machine learning (e.g., reinforcement learning) can optimize this rearrangement for complex geometries like the hexagonal lattice.

Helium-3's low mass requires tighter traps (higher NA or shorter wavelengths) to achieve sufficient trap depth. Carbon-13's trapping is speculative, as it's typically studied in molecular or solid-state forms (e.g., diamond NV centers). The SLM must generate distinct trap types: deep Gaussian traps for Carbon-13 at lattice points and shallower traps (e.g., optical vortices or Airy beams) for Helium-3 in interstitial spaces. This hybrid trap array is feasible with advanced SLM programming but not explicitly demonstrated in the literature.

After capture, the traps are maintained by continuous laser illumination, with the SLM adjusting the hologram to compensate for thermal drifts or intensity fluctuations. Ramsey interferometry or parametric driving can measure trap frequencies and homogenize intensities across the array (e.g., achieving 0.3% intensity uniformity).

U.S. Pat. No. 6,055,106 to Grier, discussed above, discloses holographic optical tweezers using computer-generated holograms (CGHs) projected via SLMs to create multiple optical traps in arbitrary 3D configurations, including lattice patterns. The patent describes dynamic reconfiguration of traps to manipulate particles (e.g., atoms) and overlap with a sample by aligning the laser beam with a target region. The patent also describes the use of SLMs to form traps and move particles, applicable to rearranging atoms into a hexagonal lattice. The patent also discusses forming traps with SLMs, overlapping with a sample (analogous to a cold atomic cloud), and activating traps by focusing laser light to capture particles.

U.S. Pat. No. 7,492,529, to Pakdaman, is entitled Bi-Convex Solid Immersion Lens. The summary, detailed description, and drawings of the patent are hereby incorporated herein by reference. This patent describes an advanced holographic optical tweezer system using SLMs to generate dynamic trap arrays, including 2D and 3D lattices. The patent includes descriptions of methods for real-time hologram calculation to adjust trap positions and intensities, enabling precise overlap with a sample and capture of particles. The patent also discusses feedback control for trap activation and rearrangement, relevant to achieving single-atom trapping in a hexagonal lattice. The patent describes dynamic trap formation, alignment with a sample, and activation via SLM-controlled laser focusing, with feedback for high-fidelity atom positioning.

U.S. Patent Application Publication US 2004/0089798 to Gruber et al. is entitled System and Method of Sorting Materials Using Holographic Laser Steering. The summary, detailed description, and drawings of the application are hereby incorporated herein by reference. The application discloses a method for creating holographic optical traps using SLMs to split a laser beam into multiple traps, including periodic arrays like hexagonal lattices. It describes aligning the trap array with a target (e.g., a cold atomic cloud) using imaging feedback and activating traps to capture particles via optical dipole forces. The application is relevant to the precise control needed for Carbon-13 and Helium-3 trapping, though not specific to those atoms. The application describes SLM-based trap formation, overlapping with a target sample, and activation for particle capture.

U.S. Pat. No. 9,176,309 to Koenig et al. is entitled Flexible Nonlinear Laser Scanning Microscope for Noninvasive Three-Dimensional Detection. The summary, detailed description, and drawings of the patent are hereby incorporated herein by reference. This patent discusses holographic optical tweezers with SLMs for creating complex trap arrays, including lattices, and manipulating particles with high precision. It discloses methods for overlapping traps with a sample and activating them to trap particles, with applications to microscopic systems (potentially including atoms). The patent's focus on dynamic reconfiguration supports the rearrangement process for a hexagonal lattice. The processes described include forming and aligning trap arrays, activating traps, and dynamic rearrangement of trapped particles.

### Fluorescence Imaging

Fluorescence imaging can be used to ensure the lattice points are filled with atoms. Following the activation of the traps to capture the atoms, fluorescence imaging can be used, as mentioned above. Fluorescence imaging uses additional lasers to excite the atoms and detect emitted photons to verify which traps contain atoms. The objective is to achieve single-atom occupancy in the lattice structure, since multiple atoms in a trap can lead to loss of control. If necessary, atoms can be moved between traps.

Generally, fluorescence imaging helps identify defects in atomic lattices by shining a laser on the lattice, which makes the atoms glow. If a spot doesn't glow, it likely means an atom is missing. If a spot glows brighter than expected, it might mean there's an extra atom. This method uses special cameras to capture these light signals, making it easier to spot where the lattice isn't perfect.

When fluorescence imaging is used to detect the presence of atoms, the lattice is illuminated with a high-intensity laser beam tuned to a wavelength that excites the atoms, typically near-resonant with an atomic transition (e.g., a broad 30 MHz transition at 401 nm for erbium, as noted in recent studies). The excited atoms emit fluorescence as they return to their ground state, which is captured using a sensitive imaging system, such as an Electron Multiplying (EM) Charge-Coupled Device (CCD) camera. This process scatters approximately 80 photons per microsecond, enabling high-resolution imaging.

Lattice sites without atoms do not emit fluorescence, appearing as dark spots in the image. This absence is a direct indicator of a vacancy, crucial for identifying defects in the lattice structure. Extra atoms, located in interstitial positions, may result in additional or brighter fluorescence spots. The intensity and location of these spots can indicate the presence of more atoms than expected, aiding in the detection of interstitial defects.

To enhance resolution, especially for closely spaced lattice sites, techniques like accordion lattices are employed. These expand the lattice spacing (e.g., to 3 μm, 4 μm, or 6 μm in 80 ms, with a loss rate <1%) before imaging, making it easier to resolve individual atoms and detect defects accurately. This is particularly useful for hexagonal lattices where site spacing might otherwise be diffraction-limited.

Fluorescence imaging can be used to identify defects in hexagonal lattice structures made by holographic optical tweezers, such as missing or extra atoms. Fluorescence imaging detects defects by illuminating atoms with a laser, exciting them to emit light. The emitted fluorescence shows bright spots for present atoms and dark spots for vacancies, helping identify missing or extra atoms.

Expanding lattice spacing, e.g., with accordion lattices, can be done to improve resolution for detecting individual atom occupancy.

Fast imaging, like 2.4 μs durations, allows high-fidelity defect detection with minimal disturbance. Number-resolved imaging can be used to distinguish exact atom numbers at each site, crucial for identifying vacancies and interstitials.

Finally, the number of lattice sites (e.g., from 10,000 to 100,000 atoms) by expanding the SLM's field of view or using multiple microlens arrays to replicate the Talbot effect over a larger volume. Optimize trap depth and periodicity for larger lattices by increasing laser power or using advanced cooling techniques like resolved sideband cooling. This process, while complex, enables the creation of tailored 3D hexagonal lattices with two atom species, offering applications in quantum simulation, materials science, and nanotechnology.

What is claimed as my invention is:

1. A composition of matter comprising a 3D hexagonal crystal lattice having a Group 14 atom at one or more lattice points and a Group 18 atom in one or more spaces between the lattice points.

2. The composition of matter of claim 1, wherein the 3D hexagonal crystal lattice has a Lonsdaleite configuration.

3. The composition of matter of claim 1, wherein the Group 14 atom is carbon.

4. The composition of matter of claim 1, wherein the Group 18 atom is helium.

5. The composition of matter of claim 1, wherein the Group 18 atom is helium-3.

6. A method of making a composition of matter comprising a 3D hexagonal crystal lattice having a Group 14 atom at one or more lattice points and a Group 18 atom in one or more lattice spaces.

7. The method of claim 6, wherein the 3D hexagonal crystal lattice has a Lonsdaleite configuration.

8. The method of claim 6, wherein the Group 14 atom is carbon.

9. The method of claim 6, wherein the Group 18 atom is helium.

10. The method of claim 6, wherein the Group 18 atom is helium-3.
